(19) United States
(12) Patent Application Publication
(10) Pub. No.: US 2024/0083131 A1
(43) Pub. Date: Mar. 14, 2024

(54) CASE ERECTOR

(71) Applicant: LAMUS ENTERPRISES INC., VANCOUVER (CA)

(72) Inventor: JOE AUGUSTINE LAM, VANCOUVER (CA)

(21) Appl. No.: 17/944,526

(22) Filed: Sep. 14, 2022

(51) Int. Cl. B31B 50/80

(52) U.S. Cl. CPC B31B 50/804; B31B 2100/00

(57) ABSTRACT

The present invention relates to a method of erecting a flat case blank into a squared or erected condition using an erector mechanism that includes two arms interconnected by a pivotal axis and each mounting a gripper and wherein one of said grippers is fixed to its arm and the other is slidably mounted on its arm for movement radially of the pivotal axis.

### CROSS REFERENCE TO RELATED APPLICATIONS

### Statement Regarding Federally Sponsored Research or Development

Not Applicable

### REFERENCE TO MICROFICHE APPENDIX

Not Applicable.

### FIELD OF INVENTION

The present invention relates to a case or carton erector for erecting flat cases or carton blanks into an erected or squared condition, more particularly an erector wherein one of the grippers is moveable relative to its supporting arm or plate.

### BACKGROUND OF THE PRESENT INVENTION

There are many case erecting apparatuses employing different erection methods being used in the industry. Examples include U.S. Pat. No. 7,788,881 that employs a center-less semi-circular channel; U.S. Pat. No. 9,126,380 that employs multiple bar linkages; U.S. Pat. No. 6,913,568 that uses a parallelogram linkage driven by a crank and connecting rod; U.S. Pat. No. 7,510,517 employing two servo driven grippers travel at 90 degrees to grip opposite side of the case blank, erecting the case blank with a parallel motion.

It is also a common erecting method to grip both sides (opposed main panels) of the flat case or carton blank, and then the separating the gripping plates to open the flat case and move the adjacent major and minor panels into mutually perpendicular position. This method requires the flat blank to be individually pulled out and separated from a stack of flat cases or blanks so that gripping plates can grip from opposite sides of the blank.

Attention is directed to U.S. Pat. Nos. 4,553,954, 6,080,095 and 7,766,808 each of which discloses a system that grips the flat case or carton (bank) using gripping pins that penetrate from the end edge into the flute area between the liners of the major and minor flaps to grip the blank. These pins are mounted on major and minor gripping plates or in this arrangement pin plates that engage with the major and minor panels of the carton blank. A flat case or carton blank (panels in face-to-face contact i.e., one major and minor panel in contact with the opposed major and minor panels) is received between the major and minor pin plates and the gripping pins on the minor pin plate engage with the adjacent minor panel and the pins on the major pin plate engage with their adjacent major panel and the carton is erected by pivoting the minor pin plate on a hinge axis into a position perpendicular to the major pin plate. The hinge axis is in very close proximity to the folding line of the blank between the major and minor flaps that are in engagement with the gripping pins to minimize the relative movement between the gripping pins and the panels with which they are engaged.

In these devices the folding line pivot of the carton needs to be as close to the pivot of the gripping panels or folding arms carrying the gripping elements as possible to minimize the relative movement of the gripper and panel it is gripping as the case is erected to position the major and minor flaps at 90 degrees to each other. It is apparent the gripping is rotated on a shaft and bushing which contributes to the spacing of the folding line of the carton and the pivot of the gripping panels. A ½″ space difference between the axis of the shaft and the adjacent fold line of the carton blank can cause almost 1 inch of relative movement of the gripping element and the gripped panel. This amount of relative movement is not acceptable particularly when vacuum cup grippers are being used as the vacuum suction cups move on the corrugated surface, it will cause serious leakage and loosing the suction.

The above mentioned patents have various mechanisms to address the difference between the folding line of the carton and the pivoting center of the gripping panel or folding arm which are complicated and costly. Most importantly, the mechanisms determine the folding line of the carton and force the opening of the carton mechanically, the carton pivot point is set mechanically regardless of misalignment of the folding line of the case blank, thickness of the carton or any other adjustment variants.

The present invention mounts one or more grippers on a carriage slidably mounted on a folding arm of the erector so that the gripper(s) when anchored to the panel of the carton move relative to the folding arm as the folding arm moves to erect the caron or case to position the major and minor panels of the case at 90° to each other. This permits the carton blank to fold naturally on its own folding line. The free sliding of the gripper on its mounting arm allows a some misalignment, inconsistency of the case blanks and machine adjustment variants that affect the forming and squaring of the case blank.

### BRIEF DESCRIPTION OF THE PRESENT INVENTION

It is an object of the present invention to provide Broadly the present invention relates to case erector for erecting a flat case blank comprising a first arm pivotably interconnected on an erector pivotal axis to a second arm, a first gripper mounted on said first arm and positioned to grip a first panel of said bank when said erector is in an initial gripping position and a second gripper positioned to grip a second panel of said blank when said erector is in said initial gripping position, said second gripper being slidably mounted on said second arm for movement along on said second arm radially relative to said erector pivotal axis when said second arm is moved relative to said first arm by rotation on said pivotal axis.

Preferably said second gripper is biased toward said erector pivotal axis by a biasing device that preferably is in the form of at least one spring.

The present invention also relates to method of erecting a case using the case erector of the present invention comprising, gripping a first panel of a flat case blank with a first gripper mounted on a first arm, gripping a second panel of said blank with a second gripper mounted on a second arm, said first and second panels being in common plain and interconnected by a fold line, moving said first and second grippers in a direction perpendicular to said common plain to remove said bank from a stack of said blanks, rotating said second arm relative to first arm on a pivotal axis interconnecting said first and second arms, said pivotal axis being spaced from said fold line, said second gripper remaining in fixed position relative to said second panel and moves relative to said second arm during said rotating to erect said case from said flat blank into a squared condition with said first and second panels in mutually perpendicular relationship.

### BRIEF DESCRIPTION OF THE SEVERAL VIEWS OF THE DRAWINGS

Further features, objects and advantages will be evident from the following detailed description of the preferred embodiments of the present invention taken in conjunction with the accompanying drawings in which;

FIG. 1 is a side elevation of the case or carton erector showing the erector in its initial gripping position and illustrating various paths of movement of the gripper that is movably mounted on its mounting arm during the folding operation to erect the case or carton erection.

FIG. 2 is a plan view of the case erector.

FIG. 3 is a section along the line 3-3 in FIG. 2 showing the mounting of the moveable gripper.

FIG. 4 is an elevation similar to FIG. 1 but showing the erector about one half way into the folding of the case into erected position.

FIG. 5 is an elevation similar to FIG. 4 but showing the case in erected condition and further the different arc of travel of the gripper showing what would occur if the gripper were fixed to the arm and the arc followed when the gripper is permitted to slide as provided for with the present invention.

FIGS. 6 and 7 illustrate the operation of the present invention in withdrawing the flat case from a stack and folding same into erected condition.

### DETAILED DESCRIPTION OF THE INVENTION

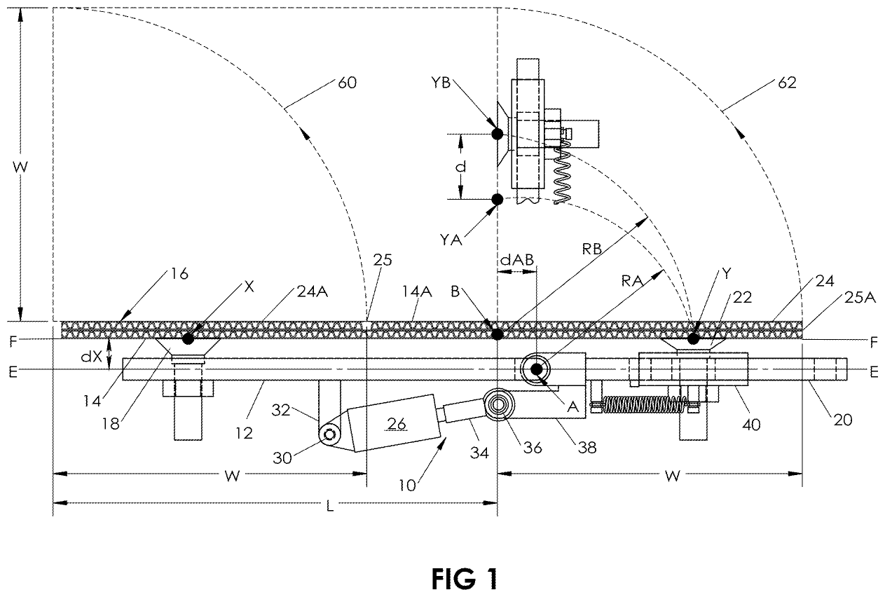

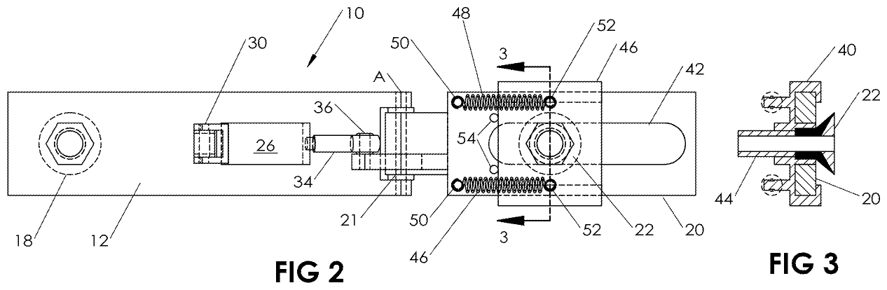

As shown in FIGS. 1 and 2 (erector 10 perse in FIG. 2) the case erector 10 of the present invention which is comprised of a first arm 12 which in the illustrated arrangement is the major arm or the arm 12 that mounts the first gripper 18 that is used to grip the major panel 14 of the flat case or carton 16 (case blank) and a second arm 20 that in the illustrated arrangement is a minor arm 20 that mounts the second gripper 22 that is used to grip the minor panel 24 of the case 16. In the illustrated arrangement the grippers 18 and 22 are in the form of suction cups but any suitable gripper such as pin type grippers may be used.

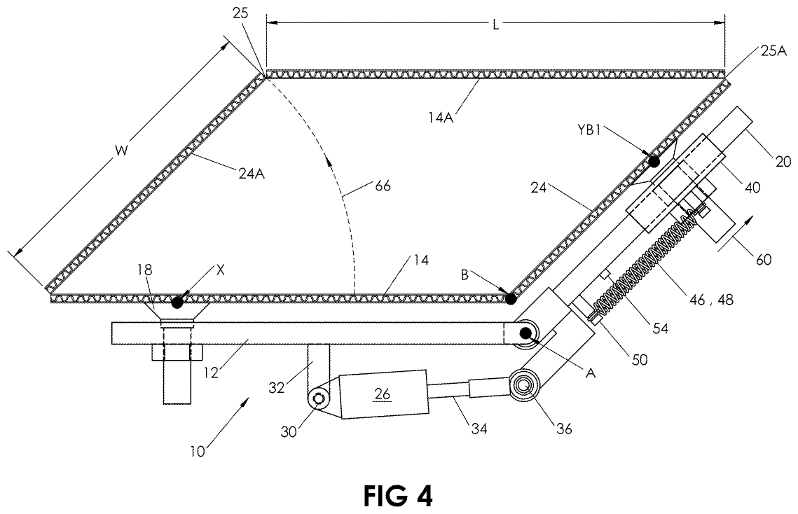

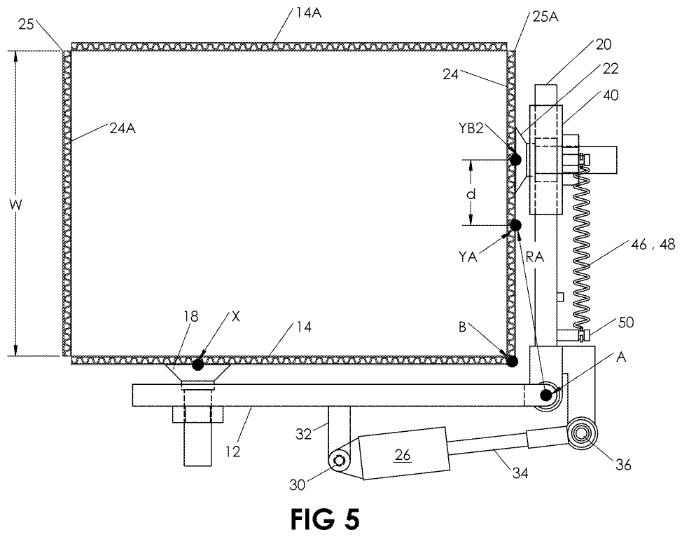

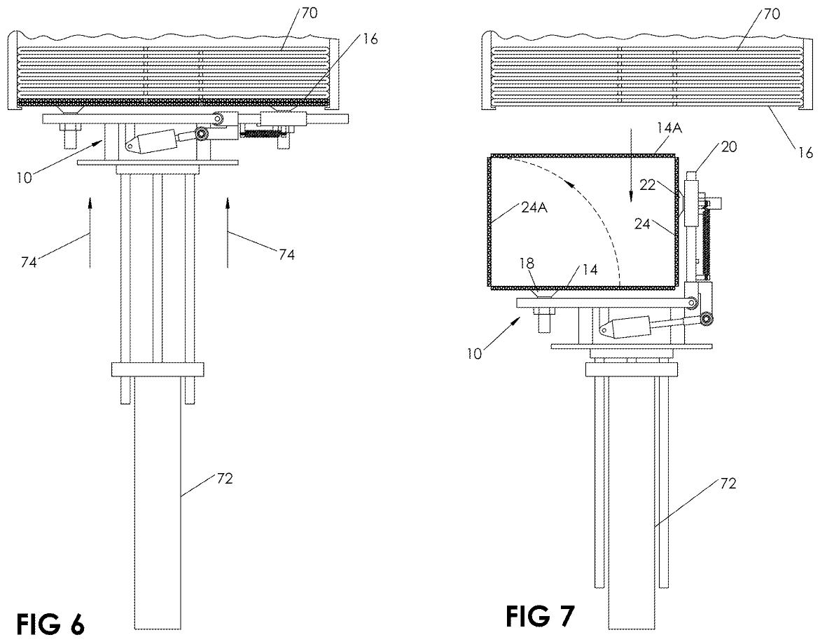

The first and second arms 12 and 20 are hinged together as indicated by the axel A with the arm 20 being received in the adjacent out portion of the arm 12 (see FIG. 2). The panels 14 and 24 of the blank 16 are interconnected by a fold line B on which the panels are folded relative to each other (it will be apparent there is an opposing major panel 14A and an opposing minor panel 14A (see FIGS. 4 and 5) that when the case is erected will be mutually perpendicular). The longitudinal axes of the fold line B and axel A are parallel and as illustrated are spaced apart in the axial direction (parallel to the plain F-F of the flat blank 16 and in the direction perpendicular to the plain F-F by a distance dX. The arms 12 and 20 in their initial position to pick up a blank from a magazine 70 (see FIGS. 6 and 7) are in a plain E-E which contains the axis A and extends substantially parallel to the plain F-F defined by the flat blank 16. These plains E-E and F-F are spaced a distance dX.

An activator 26 (normal a pneumatic activator but other types of activator may be used) has one end (fixed end in this case) pivotably mounted as indicated at 28 adjacent to the free end 30 of a post 32 that is fixed to and extends from the first arm 12 and its extendable shaft 34 pivotably pivotably connected as indicated at 36 to the free and of an L shaped arm 38 the opposite end of which is fixed to the second arm 20.

The second gripper 22 is fixed to a carriage 40 which is slidably mounted on the arm 20 (see FIGS. 2 and 3) so that it may move axially of the arm 20 and radially of the axis A as required as will be described below. The arm 20 is provided with a slot 42 through which the connecting elements 44 to actuate the gripper 22 (in this case piping) are accommodated to permit them to slide along arm 20 with the carriage 40.

A biasing device which in the illustrated arrangement is composed of a pair of parallel springs 46 and 48 each connect at one end to the arm 20 and at their opposite ends to the carriage 40 as indicated by the connecting pins 50 on the arm 20 and 52 on the carriage 40. The springs 46 and 48 in rest position hold the carriage 40 against the stops 54 projecting from the arm 20. The operation of the invention will now be described with reference to FIGS. 1, 4, 5, 6 and 7. As shown in FIG. 1 the width of the minor panels 24 and 24A is designated as width W and that of the major panels 14 and it opposite major panel 14A as L (see also FIGS. 4 and 5). When the blank 16 is erected from the flat condition show in FIG. 1 to the erected position shown in FIGS. 5 and 7 the fold line 25 between the panels 24A and 14A moves along the arc 60 and the fold line 25A between the panels 24 and 14A is moved along the arc 62.

During the erection of the case 16 the grip point X does not move relative to the panel 14 nor does the grip point Y. Maintaining the position of grip point Y relative to the panel 24 is obtained by movement of grip point Y relative to the arm 20. As shown in FIG. 1 the gripp point Y is able to follow the arc RB as it can move axially of the arm 20 as indicated by arrow 60 in FIG. 4 by simply expanding the biasing device (springs 46 and 48) so that no relative movement between the panel 24 and the grip point Y occurs and the point Y arrives at point YB. This is important in that if the grip point Y were fixed to the arm 20 it would follow the arc RA and arrive at point YA a distance d from point YB. The distance d is significant as it will likely release and/or cause damage to panel 24.

In operation the erector 10 is set up so that the carton folding line B is positioned offset from the folding arm pivot A by a distance dAB measured parallel to the plain F-F of the blank 16 The offset distance is designed based on dX the distance between the plains E-E and F-F to keep gripping point Y stationary as the carton being erected. This arrangement generally means the fold line B and pivot axis A are offset from each other along a line extending at about 45° to the planes E-E and F-F.

Turning to FIGS. 6 and 7 in operation in the illustrated version the erector 10 in its initial gripping position (i.e. both arms 12 and 20 in the same plain E-E as shown in FIG. 1) is positioned below a magazine 70 containing a stack formed by a plurality of flat case blanks 16 with their axes F-F substantially horizontal. The erector 10 is mounted on a vertical post 72 that is moved up as indicated by the arrows 74 to position the erector substantially as illustrated in FIG. 1 where the grippers 18 and 22 grip the panels 14 and 24 respectively. When the grippers 18 and 22 are gripping the panels 14 and 24 the erector 10 is moved in the opposite direction to arrows 74 to pull the gripped blank 16 from the magazine 70 and when in the position illustrated in FIG. 7 the blank 16 is erected or squared by moving the arm 20 as illustrated in FIGS. 4, 5 and 7 to the position where it is substantially perpendicular to the arm 12.

As above indicated when the arm 20 is rotated to the position perpendicular to the arm 12 i.e., perpendicular to the plains E-E and/or F-F the carriage 40 and gripper 22 slide along the arm 20 so that little if any stress is put on the panel 24 by the gripper 22.

Having described the invention, modifications will be evident to those skilled in the art without departing from the scope of the invention as defined in the appended claims.

1. A case erector for erecting a flat case blank comprising: a first arm pivotably interconnected on an erector pivotal axis to a second arm, a first gripper mounted on said first arm and positioned to grip a first panel of said blank when said erector is in an initial gripping position, a second gripper positioned to grip a second panel of said blank when said erector is in said initial gripping position, said second gripper being slidably mounted on said second arm for movement along and on said second arm radially relative to said erector pivotal axis when said second arm is moved relative to said first arm by rotation on said pivotal axis, and a biasing device connected to said second gripper and operative to bias said second gripper toward said erector pivotal axis and into a rest position.

2. (canceled)

3. The case erector as defined in claim 1, wherein said biasing device is at least one spring.

4. A method of erecting a case, comprising: gripping a first panel of a flat case blank with a first gripper mounted on a first arm, gripping a second panel of said blank with a second gripper slidably mounted on a second arm, said first and second panels being in common plain and interconnected by a fold line, moving said first and second grippers in a direction perpendicular to said common plain to remove said bank from a stack of said blanks, rotating said second arm relative to first arm on a pivotal axis interconnecting said first and second arms, said pivotal axis being spaced from said fold line, said second gripper remaining in fixed position relative to said second panel and moves relative to said second arm during said rotating to erect said case from said flat blank into a squared condition with said first and second panels in mutually perpendicular relationship, wherein said second gripper is biased toward said pivotal axis by a biasing device connected to said second gripper and operative to bias said second gripper toward said pivotal axis and into a rest position.
